(19) United States
(12) Patent Application Publication
(10) Pub. No.: US 2025/0126642 A1
(43) Pub. Date: Apr. 17, 2025

(54) WIRELESS TRANSCEIVER DEVICE, WIRELESS TRANSMISSION HANDLING METHOD THEREOF, AND WIRELESS COMMUNICATION SYSTEM

(71) Applicant: Realtek Semiconductor Corporation, Hsinchu (TW)

(72) Inventors: Wen-Yung LEE, Hsinchu (TW); Chia-Yu HSU, Hsinchu (TW); Jhe-Yi LIN, Hsinchu (TW)

(21) Appl. No.: 18/900,626

(22) Filed: Sep. 27, 2024

(30) Foreign Application Priority Data
Oct. 13, 2023 (TW) 112139261

(51) Int. Cl. H04W 74/0808; H04W 74/08; H04W 74/0833

(52) U.S. Cl. CPC H04W 74/0808; H04W 74/085; H04W 74/0866

(57) ABSTRACT

A wireless transceiver device includes a communication module and a processor. The communication module is used for receiving and transmitting radio frequency signals. The processor is coupled to the communication module and used for performing the following operations: determining whether to perform a spatial reuse transmission when detecting an overlapping basic service set (OBSS) packet; performing countdown of a spatial reuse backoff counter in response to determining that the spatial reuse transmission is to be performed; performing countdown of an enhanced distributed channel access (EDCA) backoff counter after the OBSS packet is transmitted; and transmitting a data packet via the communication module when one of the spatial reuse backoff counter and the EDCA backoff counter expires.

### RELATED APPLICATIONS

This application claims priority to Taiwan Application Serial Number 112139261, filed Oct. 13, 2023, which is herein incorporated by reference.

### BACKGROUND

### Technical Field

The present disclosure relates to spatial reuse transmission, and more particularly to a wireless transceiver device that is capable of simultaneously activating an enhanced distributed channel access (EDCA) contention function and a spatial reuse contention function to perform a spatial reuse transmission, a wireless transmission handling method thereof, and a wireless communication system.

### Description of Related Art

The IEEE 802.11ax standard specifies a spatial reuse mechanism, which aims to have wireless resources of the same frequency band of overlapped basic service sets (BSSs) reusable, thereby increasing the usage efficiency of the frequency band. However, according to the current transmission specification, it may be difficult for packets to be successfully received during the period of spatial reuse transmission due to power constraints, and consequently the spatial reuse contention has to be reperformed, resulting in increasing of the transmission latency.

### SUMMARY

One aspect of the present disclosure directs to a wireless transceiver device which includes a communication module and a processor. The communication module is configured to perform radio signal transmissions and receptions. The processor is coupled to the communication module, and is configured to perform the following operations: determining whether to perform a spatial reuse transmission when an overlapping basic service set (OBSS) packet is detected by the communication module; performing countdown of a spatial reuse backoff counter in response to determining that the spatial reuse transmission is to be performed; performing countdown of an EDCA backoff counter after the OBSS packet is transmitted; and transmitting a data packet via the communication module when one of the spatial reuse backoff counter and the EDCA backoff counter expires.

Another aspect of the present disclosure directs to wireless transmission handling method which is adapted to a wireless transceiver device and includes: determining whether to perform a spatial reuse transmission when detecting an OBSS packet; performing countdown of a spatial reuse backoff counter in response to determining that the spatial reuse transmission is to be performed; performing countdown of an EDCA backoff counter after the OBSS packet is transmitted; and transmitting a data packet when one of the spatial reuse backoff counter and the EDCA backoff counter expires.

Yet another aspect of the present disclosure directs to a wireless communication system which includes a first wireless transceiver device and a second wireless transceiver device that is configured to wirelessly communication connect to the first wireless transceiver device and belonging to the same BSS as the first wireless transceiver device. The second wireless transceiver device performing the following operations: determining whether to perform a spatial reuse transmission when detecting an OBSS packet; performing countdown of a spatial reuse backoff counter in response to determining that the spatial reuse transmission is to be performed; performing countdown of an EDCA backoff counter after the OBSS packet is transmitted; and transmitting a data packet to the first wireless transceiver device when one of the spatial reuse backoff counter and the EDCA backoff counter expires.

### BRIEF DESCRIPTION OF THE DRAWINGS

The foregoing aspects and many of the accompanying advantages of the present disclosure will become more readily appreciated as the same becomes better understood by reference to the following detailed description, when taken in conjunction with the accompanying drawings.

FIG. 1 is a schematic diagram of a wireless communication system in accordance with some embodiments of the present disclosure.

FIG. 2 is a schematic block diagram of a wireless transceiver device in accordance with some embodiments of the present disclosure.

FIG. 3 shows the relationship between the power detection parameter and the transmission power used for OBSS.

FIG. 4 is a functional block diagram related to generation of signals used for determining to perform countdown of a spatial reuse backoff counter and an EDCA backoff counter in the processor in FIG. 2.

FIG. 5A is an example of simultaneously enabling an EDCA contention function and a spatial reuse contention function to perform a spatial reuse transmission.

FIG. 5B is another example of simultaneously enabling an EDCA contention function and a spatial reuse contention function to perform a spatial reuse transmission.

FIG. 6 is a schematic flowchart of a wireless transmission handling method adopted in the wireless transceiver device in FIG. 2.

### DETAILED DESCRIPTION

The detailed explanation of the present disclosure is described as following. The described preferred embodiments are presented for purposes of illustrations and description, and they are not intended to limit the scope of the present disclosure.

In the context, wireless transceiver devices can be used to represent a number of different embodiments, including but not limited to, mobile wireless transceiver devices such as stations (STAs), laptops, mobile phones, tablet computers, and/or fixed wireless transceiver devices such as access points (APs), routers, switches, computer equipment, server equipment, and workstations. In addition, wireless transceivers can support multiple-input multiple-output (MIMO) transmissions, multiple-input single-output (MISO) transmissions, single-input multiple-output (SIMO) transmissions, and/or single-input single-output (SISO) transmissions.

According to the current Wi-Fi system specifications, the transmission modes adopted in the Wi-Fi system may include orthogonal frequency division multiplexing (OFDM) transmission modes, High Throughput (HT) modes, Very High Throughput (VHT) modes, High Efficiency (HE) modes, and Extremely High Throughput (EHT) modes, in which the HT modes, the VHT modes, the HE modes, and the EHT modes respectively correspond to various generations of wireless local area networks (WLANs) such as Wi-Fi 4, Wi-Fi 5, Wi-Fi 6, and Wi-Fi 7. More transmission modes are usable for a wireless transceiver device if the hardware specification thereof is better and the Wi-Fi system supported thereby is more advanced. The embodiments of the present disclosure may also be applied to other wired and/or wireless communication technologies such as cellular network, Bluetooth, local area network (LAN) and/or Universal Serial Bus (USB).

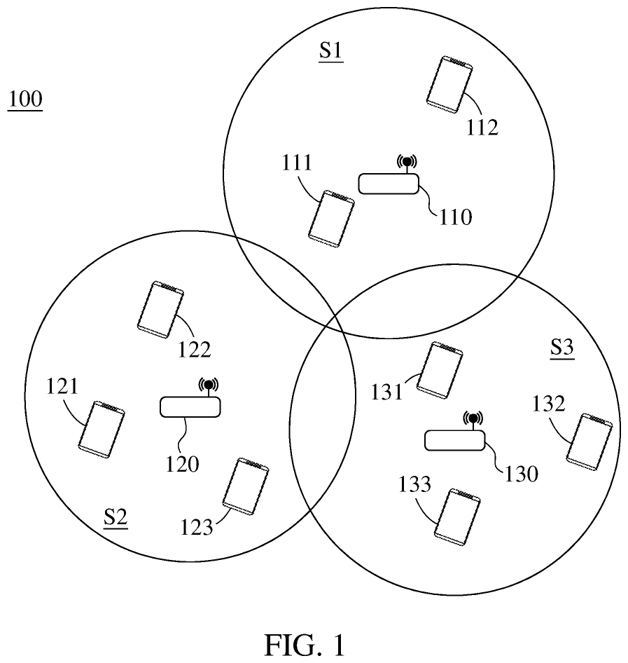

FIG. 1 is a schematic diagram of a wireless communication system 100 in accordance with some embodiments of the present disclosure. The wireless communication system 100 includes wireless access point devices 110, 120, and 130 and wireless terminal devices 111-112, 121-123, and 131-133. The wireless communication system 100 supports the Wi-Fi system specifications, and the wireless access point devices 110, 120, and 130 and the wireless terminal devices 111-112, 121-123, and 131-133 may be APs and STAs in the Wi-Fi system specifications, respectively. The wireless access point devices 110, 120, and 130 respectively provide wireless access services within a certain range, and the wireless terminal devices 111-112, 121-123, and 131-133 may perform wireless communication connections respectively with the wireless access point devices 110, 120, and 130 through a Wi-Fi channel (e.g., an IEEE 802.11 channel) to access a local area network and/or an external network (e.g., the Internet). The wireless communication connections between the wireless access point device 110 and the wireless terminal devices 111-112, the wireless communication connections between the wireless access point device 120 and the wireless terminal devices 121-123, and the wireless communication connections between the wireless access point device 130 and the wireless terminal devices 131-133 may include, but not limited to, registration procedures, authentication procedures and access procedures, establishment and release of wireless connections, and transmissions and/or receptions of control signals and/or data packets, etc.

As shown in FIG. 1, the wireless access point device 110 and the wireless terminal devices 111 and 112 belong to a BSS S1, the wireless access point device 120 and the wireless terminal devices 121, 122, and 123 belong to a BSS S2, and the wireless access point device 130 and the wireless terminal devices 131, 132, and 133 belong to a BSS S3. The BSSs S1-S3 are OBSSs with respect to each other. For example, as to the wireless access point device 110 and the wireless terminal devices 111 and 112 belonging to the BSS S1, the BSSs S2 and S3 are OBSSs. The wireless communication system 100 supports technologies of spatial reuse and BSS coloring.

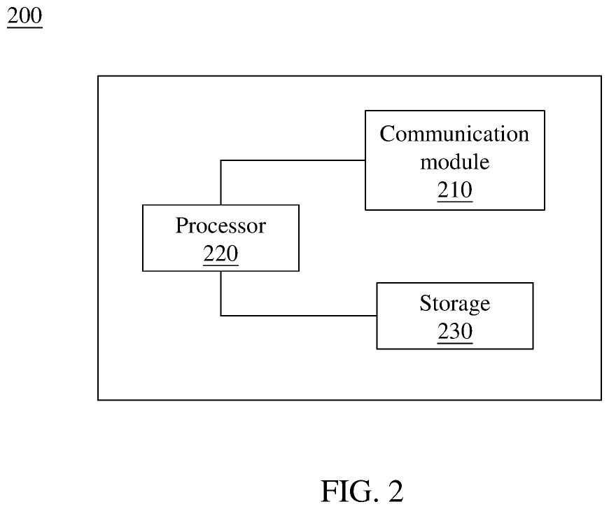

FIG. 2 is a schematic block diagram of a wireless transceiver device 200 in accordance with some embodiments of the present disclosure. The wireless transceiver device 200 may be any one of the wireless access point devices 110, 120, and 130 and the wireless terminal devices 111-112, 121-123, and 131-133 in FIG. 1. The wireless transceiver device 200 includes a communication module 210, a processor 220, and a storage 230. The communication module 210 is configured to perform radio signal transmissions and receptions. That is, the communication module 210 is configured to receive and demodulate radio signals into data packets and to modulate data packets to be transmitted into radio signals. In some embodiments, the communication module 210 may include plural antennas used to transmit and receive RF signals with multiple inputs and/or multiple outputs. The processor 220 is coupled to the communication module 210 and the storage 230 and is configured to process data packet and determine the transmission mode of the communication module 210 according to the system status for signal transmissions and receptions. The processor 220 may be, for example, but not limited to, a microprocessor or an application-specific integrated circuit (ASIC). The storage 230 may be any data storage device that can be read and executed by the processor 220. The storage 230 may be, for example, but not limited to, a subscriber identity module (SIM), a read-only memory (ROM), an erasable programmable ROM (EPROM), an electrically erasable programmable ROM (EEPROM), a random access memory (RAM), a CD-ROM, a magnetic tape, a hard disk drive, a solid-state drive, a flash memory, or another data storage device suitable for storing bit data and/or program codes.

According to the IEEE 802.11ax standard, after detecting an OBSS physical layer protocol data unit (PPDU) packet, the maximum transmission power TX_PWRₘₐₓ of the wireless transceiver device 200 after obtaining a transmit opportunity (TXOP) is determined from Equation (1):

$${TX\_PWR}_{max} = \{ \begin{matrix}unconstrained , if {OBSS\_PD}_{level} \leq {OBSS\_PD}_{min} \\ {TX\_PWR}_{ref} - ( {OBSS\_PD}_{level} - {OBSS\_PD}_{min} )\end{matrix} \qquad ( 1 )$$

where OBSS_PDₗₑᵥₑₗ is a power detection parameter, OBSS_PDₘₐₓ is a maximum power detection parameter, OBSS_PDₘᵢₙ is a minimum power detection parameter, and TX_PWR_{ref} is a reference transmission power level. The power detection parameter OBSS_PDₗₑᵥₑₗ shall satisfy Equation (2) as follows:

$$max ( {OBSS\_PD}_{min} + min ( {OBSS\_P}_{max} , {OBSS\_PD}_{min} + ( {TX\_PWR}_{ref} - TX\_PWR ) ) ) + 10 log ( PPDU\_BW / 20 MHz ) , \qquad ( 2 )$$

where PPDU_BW is the bandwidth of the OBSS packet, and TX_PWR is the transmission power usable after the wireless transceiver device 200 obtains the TXOP. The bandwidth of the OBSS packet may be, for example, a 20 MHz channel bandwidth, a 40 MHz channel bandwidth, an 80 MHz channel bandwidth, or a Per 20 MHz subchannel bandwidth. The transmission power TX_PWR used after the wireless transceiver device 200 obtains the TXOP is not greater than the maximum transmission power TX_PWRₘₐₓ. The maximum power detection parameter OBSS_PDₘₐₓ and the minimum power detection parameter OBSS_PDₘᵢₙ may be obtained from the spatial reuse parameter set element in a beacon. The maximum power detection parameter OBSS_PDₘₐₓ and the minimum power detection parameter OBSS_PDₘᵢₙ shall satisfy Equation (3) as follows:

$$- 82 dBm \leq {OBSS\_PD}_{min} \leq {OBSS\_PD}_{max} \leq - 62 dBm . \qquad ( 3 )$$

The reference transmission power level TX_PWR_{ref} is determined according to the wireless transceiver device 200. For example, if the wireless transceiver device 200 is a non-AP station, the reference transmission power level TX_PWR_{ref} of is 21 dBm.

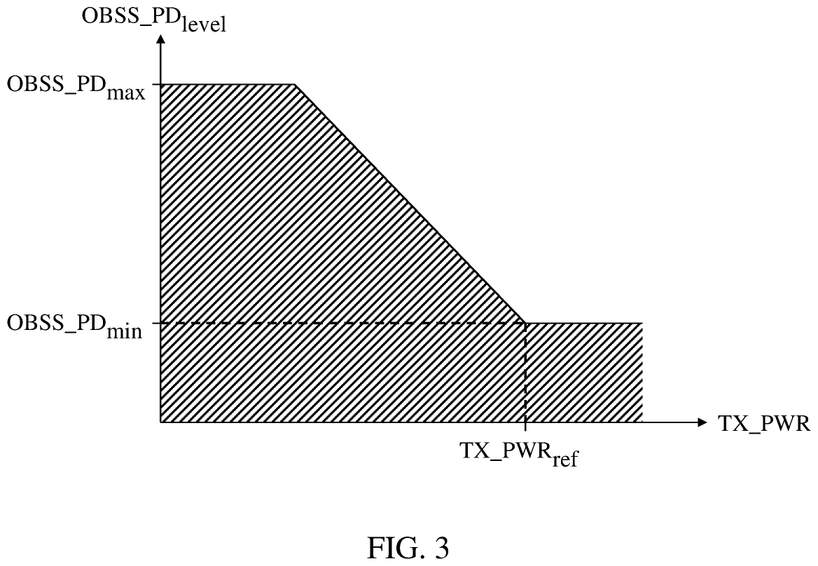

Summing the foregoing contents and Equations (1)-(3), the relationship between the power detection parameter OBSS_PDₗₑᵥₑₗ used for OBSS and the transmission power TX_PWR shown in FIG. 3 can be obtained, in which the slashed area represents the allowed range of the relationship between the power detection parameter OBSS_PDₗₑᵥₑₗ and the transmission power TX_PWR. It should be noted that, although the greater power detection parameter OBSS_PDₗₑᵥₑₗ can increase the TXOP based on spatial reuse (because packets can be transmitted when the measured power msr_pwr is less than the power detection parameter OBSS_PDₗₑᵥₑₗ, in which the measured power msr_pwr is the power of the OBSS packet detected by the antenna of the communication module 210), as can be seen from FIG. 3, the greater power detection parameter OBSS_PDₗₑᵥₑₗ corresponds to the less transmission power TX_PWR, which is likely to cause the transmitted data packet difficult to be successfully received during the power constraint period and thus the spatial reuse contention has to be reperformed, resulting in increasing of the data packet transmission latency.

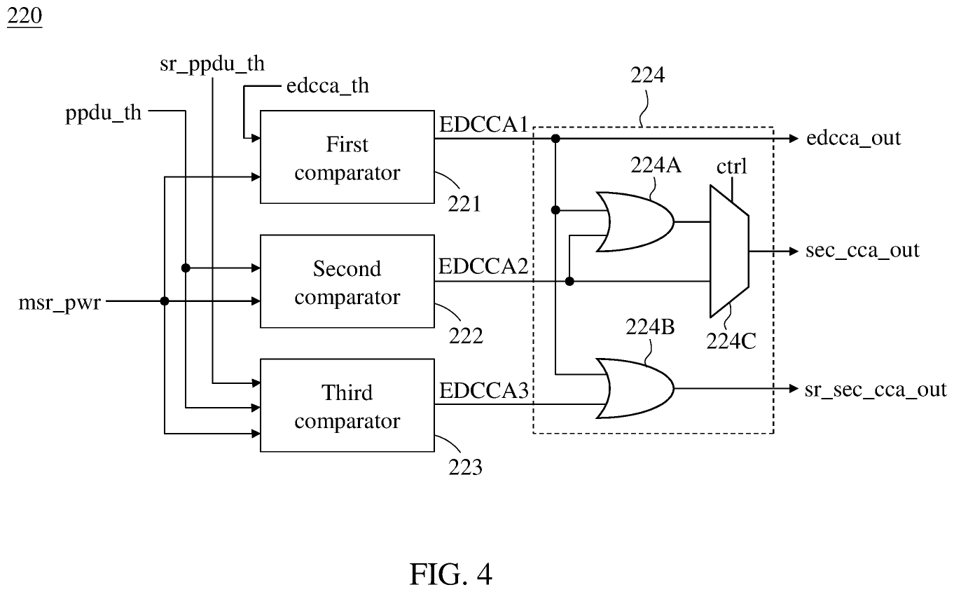

In light of this, the present disclosure provides a mechanism of simultaneously enabling an EDCA contention function and a spatial reuse contention function to perform a spatial reuse transmission. In the embodiments of the present disclosure, the wireless transceiver device 200 may simultaneously enable an EDCA contention function and a spatial reuse contention function in the period of performing a spatial reuse transmission. FIG. 4 is a functional block diagram related to generation of signals used for determining to perform countdown of a spatial reuse backoff counter and an EDCA backoff counter in the processor 220, which is configured to generate a first determination signal edcca_out, a second determination signal sec_cca_out, and a third determination signal sr_sec_cca_out according to the measured power msr_pwr, a first threshold edcca_th, a second threshold ppdu_th, and a third threshold sr_ppdu_th, and which includes a first comparator 221, a second comparator 222, a third comparator 223, and a logic circuit 224. The first comparator 221 is configured to compare the measured power msr_pwr with the first threshold edcca_th for outputting a first comparing logic level EDCCA1. The second comparator 222 is configured to compare the measured power msr_pwr with the second threshold ppdu_th for outputting a second comparing logic level EDCCA2. The third comparator 223 is configured to compare the measured power msr_pwr with the second threshold ppdu_th and the third threshold sr_ppdu_th for outputting a third comparing logic level EDCCA3. In some embodiments, the measured power msr_pwr is the power of the OBSS packet detected by the antenna in the communication module 210, the first threshold edcca_th is a threshold for detecting whether the primary channel is busy, the second threshold ppdu_th is a threshold associated with the EDCA contention function, and the third threshold sr_ppdu_th is athreshold associated with the spatial reuse contention function. When the wireless transceiver device 200 receives an OBSS packet, the processor 220 may change the power detection parameter OBSS_PDₗₑᵥₑₗ from an initial value to a detection threshold for determining the first threshold edcca_th, the second threshold ppdu_th, and the third threshold sr_ppdu_th according to the power detection parameter OBSS_PDₗₑᵥₑₗ, and changes the power detection parameter OBSS_PDₗₑᵥₑₗ from the detection threshold back to the initial value after completion of the spatial reuse transmission (e.g., obtaining an TXOP to transmit a data packet and successfully receiving a corresponding response packet), in which the detection threshold may be determined according to the bandwidth of the OBSS packet.

In some embodiments, as shown in FIG. 4, the logic circuit 224 includes OR gates 224A, 224B and a multiplexer 224C. The two inputs and the output of the OR gate 224A are coupled to the output of the first comparator 221, the output of the second comparator 222, and a first input of the multiplexer 224C, respectively. The two inputs of the OR gate 224B are coupled to the output of the first comparator 221 and the output of the third comparator 223, respectively. A second input of the multiplexer 224C is coupled to the output the second comparator 222, and a control end of the multiplexer is configured to input a control signal ctrl. If the multiplexer 224C is used for protocol data unit detection (the default of the logic circuit 224), the output and the second input of the multiplexer 224C are coupled by the control signal ctrl; otherwise, the output and the first input of the multiplexer 224C are coupled by the control signal ctrl. The first determination signal edcca_out is the first comparing logic level EDCCA1, the second determination signal sr_sec_cca_out is a logic level outputted from the output of the multiplexer 224C, and the third determination signal sr_sec_cca_out is a logic level outputted from the output of the OR gate 224B.

In other embodiments, the logic circuit 224 may be implemented by a circuit different from the content shown in FIG. 4, which can be directly thought out by a person having ordinary skill in the art according to the relationship between the measured power msr_pwr, the first threshold edcca_th, the second threshold ppdu_th, the third threshold sr_ppdu_th, the first determination signal edcca_out, the second determination signal sec_cca_out, and the third determination signal sr_sec_cca_out.

In one embodiment, if the measured power msr_pwr is greater than the first threshold edcca_th, the first comparing logic level EDCCA1 is 1; otherwise, the first comparing logic level EDCCA1 is 0. If the measured power msr_pwr is greater than the second threshold pddu_th, the second comparing logic level EDCCA2 is 1; otherwise, the second comparing logic level EDCCA2 is 0. If the measured power msr_pwr is greater than both the second threshold pddu_th and the third threshold sr_pddu_th, the third comparing logic level EDCCA3 is 1; otherwise, the third comparing logic level EDCCA3 is 0.

It is noted that the functional block diagram shown in FIG. 4 is for an OBSS packet transmitted in a specific bandwidth. In various embodiments, the processor 220 may include plural functional block diagrams shown in FIG. 4, and these functional block diagrams respectively correspond to secondary channels of different bandwidths, e.g., a secondary channel of 20 MHz bandwidth, a secondary channel of 40 MHz bandwidth, a secondary channel of 80 MHz bandwidth, and a secondary channel of Per 20 MHz bandwidth, so as to support spatial reuse transmissions of OBSS packets in various bandwidths. For example, the first threshold edcca_th and the second threshold pddu_th used for the secondary channel of 20 MHz bandwidth are respectively −62 dBm and −72 dBm, the first threshold edcca_th and the second threshold pddu_th used for the secondary channel of 40 MHz bandwidth are respectively −59 dBm and −72 dBm, the first threshold edcca_th and the second threshold pddu_th used for the secondary channel of 80 MHz bandwidth are respectively −56 dBm and −69 dBm, and the first threshold edcca_th and the second threshold pddu_th used for the secondary channel of Per 20 MHz bandwidth are respectively −62 dBm and −72 dBm.

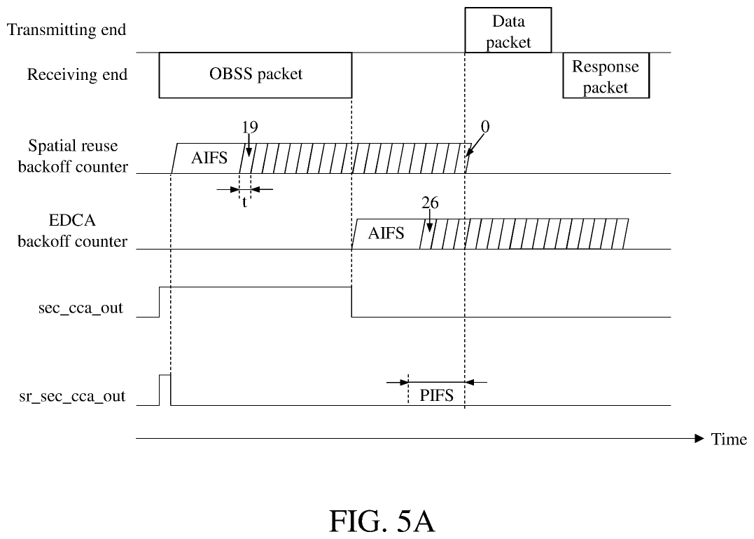

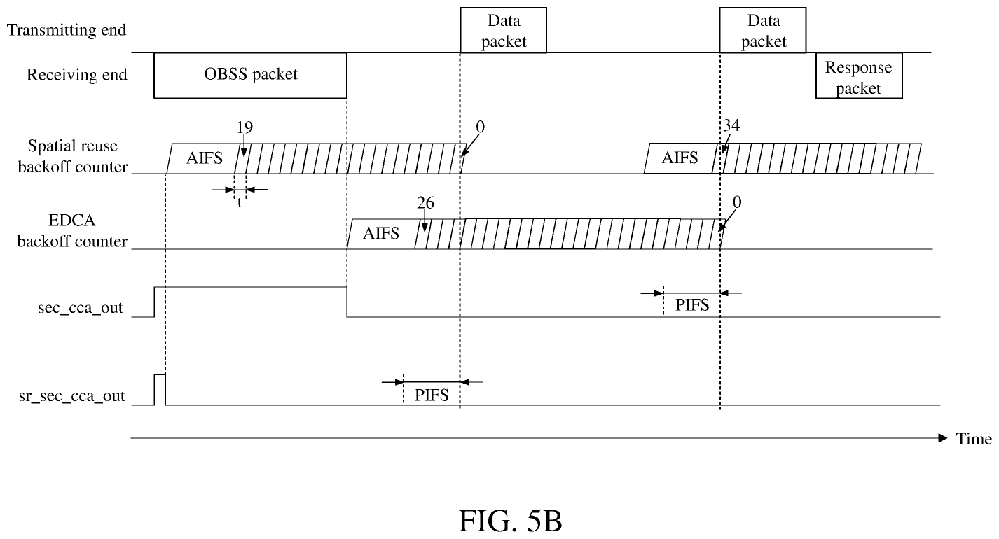

FIG. 5A is an example of simultaneously enabling an EDCA contention function and a spatial reuse contention function to perform a spatial reuse transmission. When detecting an OBSS packet (at this time the logic level of the first determination signal edcca_out is 1, which means that the primary channel is busy), the wireless transceiver device 200 changes the power detection parameter OBSS_PDₗₑᵥₑₗ from an initial value to a detection threshold and determines whether a spatial reuse transmission can be performed according to OBSS_PDₗₑᵥₑₗ that has changed to the detection threshold. During detection of the OBSS packet, the EDCA backoff counter pauses countdown due to primary channel busy by the OBSS packet, whereas the spatial reuse backoff counter performs countdown after an arbitration inter-frame space (AIFS) period under the condition in which the wireless transceiver device 200 determines that a spatial reuse transmission can be performed. In the example of FIG. 5A, during the AIFS period after the wireless transceiver device 200 determines that a spatial reuse transmission can be performed, because the clear channel assessment (CCA) performed on the secondary channel by using the third determination signal sr_sec_cca_out indicates that the secondary channel is non-busy, the spatial reuse backoff counter starts countdown (i.e., the backoff value decreases after each slot time t) at the backoff value of 19 that is randomly selected. After the transmission of the OBSS packet completes, because the measured power reduces, the logic level of the second determination signal sec_cca_out changes from 1 to 0, and during the subsequent AIFS period, the CCA performed on the secondary channel by using the second determination signal sec_cca_out indicates that the secondary channel is non-busy, and at this time the EDCA backoff counter starts countdown at the backoff value of 26 that is randomly selected. Because the spatial reuse backoff counter expires before the EDCA backoff counter (i.e., the backoff value thereof decreases to 0 first, and thus the spatial reuse backoff counter is the first expired backoff counter), and the CCA performed on the secondary channel by using the third determination signal sr_sec_cca_out indicates that the secondary channel is non-busy during the point coordination function inter-frame space (PIFS) period before the spatial reuse backoff counter expires, the wireless transceiver device 200 thus uses the secondary channel to transmit a data packet (e.g., to a wireless transceiver device that belongs to the same BSS) after the spatial reuse backoff counter expires. After transmitting the data packet and successfully receiving a response packet corresponding to the data packet, the wireless transceiver device 200 finishes the spatial reuse transmission, such as changing the power detection parameter OBSS_PDₗₑᵥₑₗ from the detection threshold back to the initial value to finish the power restriction configurations. Meanwhile, if the EDCA backoff counter does not expire, the wireless transceiver device 200 stops the EDCA backoff counter (i.e., stops the unexpired backoff counter).

FIG. 5B is another example of simultaneously enabling an EDCA contention function and a spatial reuse contention function to perform a spatial reuse transmission. In FIG. 5B, the progress from detecting an OBSS packet by the wireless transceiver device 200 to using the secondary channel to transmit a data packet by the wireless transceiver device 200 after the spatial reuse backoff counter expires is the same as the corresponding content shown in FIG. 5A and is thus not described again. However, due to the factor of power restriction configurations, the wireless transceiver device 200 may not successfully receive a response packet that corresponds to the data packet, resulting in having to retransmit the data packet. In detail, as shown in FIG. 5B, during the period in which the secondary channel is used to transmit a data packet after the spatial reuse backoff counter expires, the EDCA backoff counter keeps countdown, and the spatial reuse backoff counter performs countdown again in the condition in which the response packet is not successfully received. In the example of FIG. 5B, during the AIFS period in which the spatial reuse backoff counter performs countdown again, the CCA performed on the secondary channel by using the third determination signal sr_sec_cca_out indicates that the secondary channel is non-busy, and at this time the spatial reuse backoff counter starts countdown at the backoff value of 34 that is randomly selected. Because the EDCA backoff counter expires before the spatial reuse backoff counter (i.e., the backoff value decreases to 0 first, and thus the EDCA backoff counter is the first expired backoff counter), and the CCA performed on the secondary channel by using the second determination signal sec_cca_out indicates that the secondary channel is non-busy during the PIFS period before the EDCA backoff counter expires, the wireless transceiver device 200 thus uses the secondary channel to restart the packet transmission after the EDCA backoff counter expires. After retransmitting the transmission packet and successfully receiving a response packet corresponding to the data packet, the wireless transceiver device 200 finishes the spatial reuse transmission, such as changing the power detection parameter OBSS_PDₗₑᵥₑₗ from the detection threshold back to the initial value to finish the power restriction configurations. Meanwhile, if the spatial reuse backoff counter does not expire, the wireless transceiver device 200 stops the spatial reuse backoff counter (i.e., stops the unexpired backoff counter).

In the above descriptions of FIGS. 5A and 5B, the operations of detecting OBSS packets, sending data packets, and receiving response packets may be performed by the communication module 210, while the rest operations may be performed by the processor 220.

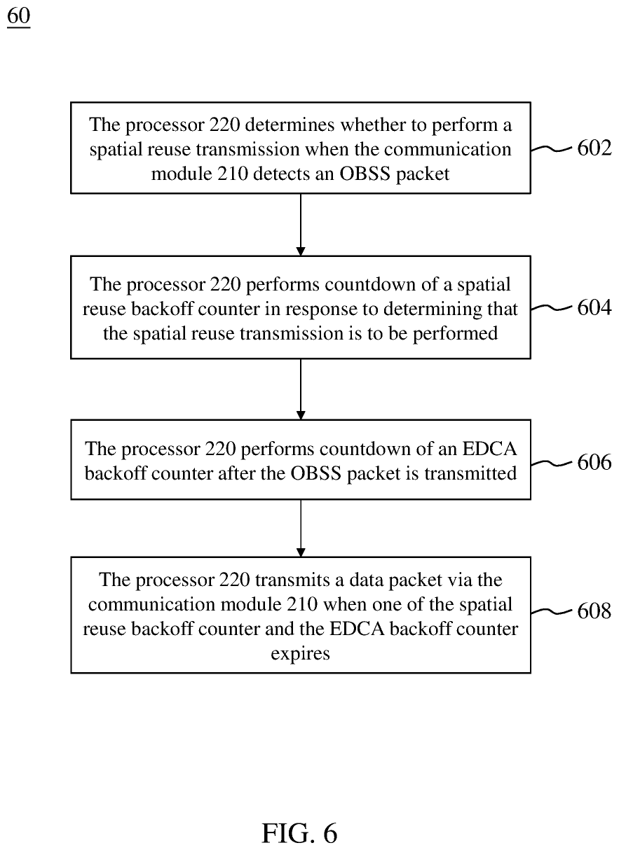

To sum up the above, the wireless transmission handling method provided in the present disclosure is applicable to any one of the wireless access point devices 110, 120, and 130, and the wireless terminal devices 111-112, 121-123, and 131-133 in the wireless communication system 100 and the wireless transceiver device 200. Taking the wireless transceiver device 200 as an example, the wireless transmission handling method used in the wireless transceiver device 200 may be summarized as a flowchart 60 in FIG. 6 in accordance with some embodiments of the present disclosure, which includes the following steps:
Step 602: the processor 220 determines whether to perform a spatial reuse transmission when the communication module 210 detects an OBSS packet.
Step 604: the processor 220 performs countdown of a spatial reuse backoff counter in response to determining that the spatial reuse transmission is to be performed.
Step 606: the processor 220 performs countdown of an EDCA backoff counter after the OBSS packet is transmitted.
Step 608: the processor 220 transmits a data packet (e.g., to a wireless transceiver device belonging to the same BSS) via the communication module 210 when one of the spatial reuse backoff counter and the EDCA backoff counter expires.

In one embodiment, the wireless transmission handling method further includes the following operations: the processor 220 finishes the spatial reuse transmission after successfully receiving a response packet corresponding to the data packet (e.g., from a wireless transceiver device belonging to the same BSS), and stops an unexpired one of the spatial reuse backoff counter and the EDCA backoff counter. In one embodiment, the wireless transmission handling method further includes the following operations: the processor 220 reperforms countdown of an expired one of the spatial reuse backoff counter and the EDCA backoff counter under a condition in which the communication module 210 does not successfully receive a response packet corresponding to the data packet in a predetermined time, and retransmits the data packet when one of the spatial reuse backoff counter and the EDCA backoff counter expires. In one embodiment, the wireless transmission handling method further includes the following operations: the processor 220 finishes the spatial reuse transmission after the communication module 210 successfully receives a response packet corresponding to the retransmitted data packet, and stops an unexpired one of the spatial reuse backoff counter and the EDCA backoff counter. In one embodiment, the wireless transmission handling method further includes the following operations: the processor 220 changes a power detection parameter corresponding to the spatial reuse transmission from an initial value to a detection threshold when the communication module detects the OBSS packet, and changes the power detection parameter from the detection threshold back to the initial value after transmitting the data packet and successfully receiving a response packet corresponding to the data packet, in which the detection value is determined according to the bandwidth of the OBSS packet. In one embodiment, the bandwidth of the OBSS packet is a 20 MHz channel bandwidth, a 40 MHz channel bandwidth, an 80 MHz channel bandwidth, or a Per 20 MHz subchannel bandwidth.

As can be seen from the foregoing, in accordance with the present disclosure of which the spatial reuse transmission performed by simultaneously enabling an EDCA contention function and a space reuse contention function, a data packet can be transmitted when one of the EDCA backoff counter and the spatial reuse backoff counter expires, and the EDCA backoff counter still continues performing countdown during the period in which the spatial reuse backoff counter expires first and the subsequent data packet transmission fails, such that the data packet are retransmitted when the EDCA backoff counter expires, and therefore the channel access delay can be further reduced, thereby improving the transmission efficiency. In addition, because the power detection parameter is adjusted during the spatial reuse transmission period (i.e., the power constraint period), the threshold for idle channel detection is increased, such that the spatial reuse backoff counter is less susceptible to the influence of the secondary channel and stops.

It will be apparent to those skilled in the art that various modifications and variations can be made to the structure of the present disclosure without departing from the scope or spirit of the present disclosure cover modifications and variations of this present disclosure provided they fall within the scope of the following claims.

What is claimed is:

1. A wireless transceiver device, comprising:
a communication module configured to perform radio signal transmissions and receptions; and
a processor coupled to the communication module and configured to perform the following operations:
determining whether to perform a spatial reuse transmission when an overlapping basic service set (OBSS) packet is detected by the communication module;
performing countdown of a spatial reuse backoff counter in response to determining that the spatial reuse transmission is to be performed;
performing countdown of an enhanced distributed channel access (EDCA) backoff counter after the OBSS packet is transmitted; and
transmitting a data packet via the communication module when one of the spatial reuse backoff counter and the EDCA backoff counter expires.

2. The wireless transceiver device of claim 1, wherein after the communication module successfully receives a response packet corresponding to the data packet, the processor finishes the spatial reuse transmission and stops an unexpired one of the spatial reuse backoff counter and the EDCA backoff counter.

3. The wireless transceiver device of claim 1, wherein the processor reperforms countdown of an expired one of the spatial reuse backoff counter and the EDCA backoff counter under a condition in which the communication module does not successfully receive a response packet corresponding to the data packet in a predetermined time, and retransmits the data packet via the communication module when one of the spatial reuse backoff counter and the EDCA backoff counter expires.

4. The wireless transceiver device of claim 3, wherein after the communication module successfully receives a response packet corresponding to the retransmitted data packet, the processor finishes the spatial reuse transmission and stops an unexpired one of the spatial reuse backoff counter and the EDCA backoff counter.

5. The wireless transceiver device of claim 1, wherein the processor changes a power detection parameter corresponding to the spatial reuse transmission from an initial value to a detection threshold when the communication module detects the OBSS packet, and changes the power detection parameter from the detection threshold back to the initial value after the communication module transmits the data packet and successfully receives a response packet corresponding to the data packet,
wherein the detection threshold is determined according to a bandwidth of the OBSS packet.

6. The wireless transceiver device of claim 5, wherein the bandwidth of the OBSS packet is a 20 MHz channel bandwidth, a 40 MHz channel bandwidth, an 80 MHz channel bandwidth, or a Per 20 MHz subchannel bandwidth.

7. A wireless transmission handling method adapted to a wireless transceiver device, the wireless transmission handling method comprising:
determining whether to perform a spatial reuse transmission when detecting an OBSS packet;
performing countdown of a spatial reuse backoff counter in response to determining that the spatial reuse transmission is to be performed;
performing countdown of an EDCA backoff counter after the OBSS packet is transmitted; and
transmitting a data packet when one of the spatial reuse backoff counter and the EDCA backoff counter expires.

8. The wireless transmission handling method of claim 7, further comprising:
finishing the spatial reuse transmission after successfully receiving a response packet corresponding to the data packet; and
stopping an unexpired one of the spatial reuse backoff counter and the EDCA backoff counter.

9. The wireless transmission handling method of claim 7, further comprising:
reperforming countdown of an expired one of the spatial reuse backoff counter and the EDCA backoff counter under a condition in which a response packet corresponding to the data packet is not successfully received in a predetermined time; and
retransmitting the data packet when one of the spatial reuse backoff counter and the EDCA backoff counter expires.

10. The wireless transmission handling method of claim 9, further comprising:
finishing the spatial reuse transmission after successfully receiving a response packet corresponding to the retransmitted data packet; and
stopping an unexpired one of the spatial reuse backoff counter and the EDCA backoff counter.

11. The wireless transmission handling method of claim 7, further comprising:
changing a power detection parameter corresponding to the spatial reuse transmission from an initial value to a detection threshold when detecting the OBSS packet; and
changing the power detection parameter from the detection threshold back to the initial value after transmitting the data packet and successfully receiving a response packet corresponding to the data packet,
wherein the detection threshold is determined according to a bandwidth of the OBSS packet.

12. The wireless transmission handling method of claim 11, wherein the bandwidth of the OBSS packet is a 20 MHz channel bandwidth, a 40 MHz channel bandwidth, an 80 MHz channel bandwidth, or a Per 20 MHz subchannel bandwidth.

13. A wireless communication system, comprising:
a first wireless transceiver device; and
a second wireless transceiver device configured to wirelessly communication connect to the first wireless transceiver device and belonging to a same basic service set (BSS) as the first wireless transceiver device, the second wireless transceiver device performing the following operations:
determining whether to perform a spatial reuse transmission when detecting an OBSS packet;
performing countdown of a spatial reuse backoff counter in response to determining that the spatial reuse transmission is to be performed;
performing countdown of an EDCA backoff counter after the OBSS packet is transmitted; and
transmitting a data packet to the first wireless transceiver device when one of the spatial reuse backoff counter and the EDCA backoff counter expires.

14. The wireless communication system of claim 13, wherein the second wireless transceiver device is configured to further perform the following operations:
finishing the spatial reuse transmission after successfully receiving a response packet corresponding to the data packet from the first wireless transceiver device; and
stopping an unexpired one of the spatial reuse backoff counter and the EDCA backoff counter.

15. The wireless communication system of claim 13, wherein the second wireless transceiver device is configured to further perform the following operations:
reperforming countdown of an expired one of the spatial reuse backoff counter and the EDCA backoff counter under a condition in which a response packet corresponding to the data packet from the first wireless transceiver device is not successfully received in a predetermined time; and
retransmitting the data packet to the first wireless transceiver device when one of the spatial reuse backoff counter and the EDCA backoff counter expires.

16. The wireless communication system of claim 15, wherein the second wireless transceiver device is configured to further perform the following operations:
finishing the spatial reuse transmission after successfully receiving a response packet corresponding to the retransmitted data packet from the first wireless transceiver device; and
stopping an unexpired one of the spatial reuse backoff counter and the EDCA backoff counter.

17. The wireless communication system of claim 13, wherein the second wireless transceiver device is configured to further perform the following operations:
changing a power detection parameter corresponding to the spatial reuse transmission from an initial value to a detection threshold when detecting the OBSS packet; and
changing the power detection parameter from the detection threshold back to the initial value after transmitting the data packet to the first wireless transceiver device and successfully receiving a response packet corresponding to the data packet from the first wireless transceiver device,
wherein the detection threshold is determined according to a bandwidth of the OBSS packet.

18. The wireless communication system of claim 17, wherein the bandwidth of the OBSS packet is a 20 MHz channel bandwidth, a 40 MHz channel bandwidth, an 80 MHz channel bandwidth, or a Per 20 MHz subchannel bandwidth.

19. The wireless communication system of claim 13, wherein the second wireless transceiver device is a station in a Wi-Fi system specification.

20. The wireless communication system of claim 13, wherein the second wireless transceiver device is an access point in a Wi-Fi system specification.
